(19) United States
(12) Patent Application Publication
(10) Pub. No.: US 2003/0105875 A1
(43) Pub. Date: Jun. 5, 2003

(54) Transmission management device of a server

(76) Inventor: Chun-Liang Lee, Taipei (TW)

Correspondence Address: BIRCH STEWART KOLASCH & BIRCH, PO BOX 747, FALLS CHURCH, VA, 22040-0747, US

(21) Appl. No.: 10/000,442

(22) Filed: Dec. 4, 2001

(51) Int. Cl. G06F 15/16

(52) U.S. Cl. 709/232; 709/253

(57) ABSTRACT

A transmission management device of a server utilizing a serial port RS232 and a bus to manage the server and to transmit data. The transmission management device includes a transmission system, a control system and an I/O (Input/Output) system. The transmission system is used for connecting independent sub-systems in the server and transmitting data. The control system is used for receiving data from an external system and interrupt signals from the Interrupting Processing Unit and for communicating with the transmission system directly. The I/O system outputs and inputs the data from the external system into the bus between the transmission system and the control system, achieving the objective of transmitting data and managing the sub-system through the server.

### BACKGROUND OF THE INVENTION

1. Field of the Invention

The invention relates to a transmission management device, in particular to a transmission management device of a server.

2. Related Art

A server in a network system provides a variety of services for different terminals, such as database, file storage, printing, email, web pages, and so on. In order to provide the above services for multiple terminals, the server needs to have the ability to process and respond to all requests and information transmitted from the multiple terminals simultaneously. In regards to hardware, multiple I/O ports have to be installed at the server to receive the information transmitted from the multiple terminals. As far as software, the server must be capable of managing the information transmitted from the multiple terminals.

Since the server has to service multiple terminals, many independent sub-systems are installed in a high-density server. Transmitting data and commands among the conventional server and the independent sub-systems or a distant system relies only on an I2C bus. However, using only the I2C bus to manage the whole server often causes the problems of information delays and inefficiency.

In summary, using the I2C bus to manage the server is not an efficient method and takes a longer time to manage. Therefore, how to efficiently transmit data and commands to achieve the objective of managing a server is an important technical issue to be resolved.

### SUMMARY OF THE INVENTION

In the view of the foregoing, the invention provides a transmission management device of a server with the objective of increasing the efficiency of transmitting information and managing independent sub-systems in a server.

According to the invention, the transmission management device of a server includes a transmission system, a control system and an I/O system. The transmission system is used for connecting independent sub-systems in the server and transmitting data. The control system is used for receiving data from an external system and interrupt signals from the Interrupting Processing Unit and for communicating with the transmission system directly. The I/O system outputs and inputs the data from the external system into a bus between the transmission system and the control system.

### BRIEF DESCRIPTION OF THE DRAWINGS

FIG. 1 is a system block diagram of the disclosed transmission management device of a server;

FIG. 2 is a system block diagram of the transmission system in FIG. 1;

FIG. 3 is a system block diagram of the control system in FIG. 1; and

FIG. 4 is a system block diagram of the I/O system in FIG. 1.

### DETAILED DESCRIPTION OF THE INVENTION

The invention discloses a transmission management device of a server. The invention utilizes a serial port RS232 and an I2C bus to manage the server and to transmit data.

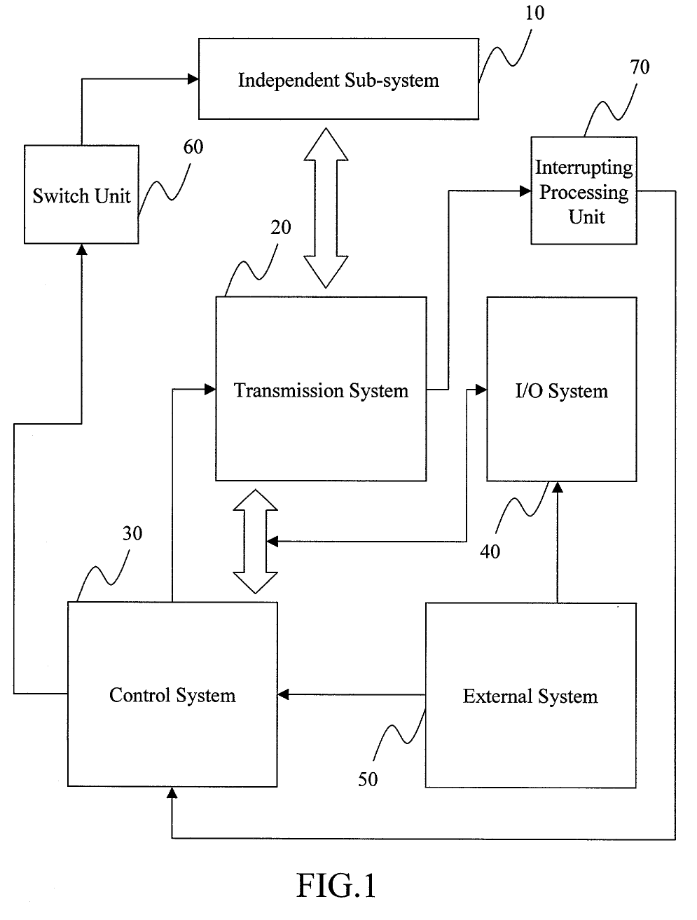

With reference to FIG. 1, in accordance with the invention, the transmission management device of a server includes: a transmission system 20, a control system 30, and an I/O system 40. The transmission system 20 connected with an independent sub-system 10 of the server is used for receiving and storing data and commands from the server and for transmitting the data and the commands to the independent sub-system 10 through the serial port RS232. The control system 30 connected with the transmission system 20 is used for receiving the data and the commands from the external system 50 and the interrupt signals form the server and for passing the data and the commands onto the transmission system 20 and onto the independent sub-system 10 through the I2C bus. The I/O system 40 connected with the external system 50 is used for transmitting the data and the commands from the external system 50 to the transmission system 20 and the control system 30, and for transmitting the data and the commands from the server to the external system 50.

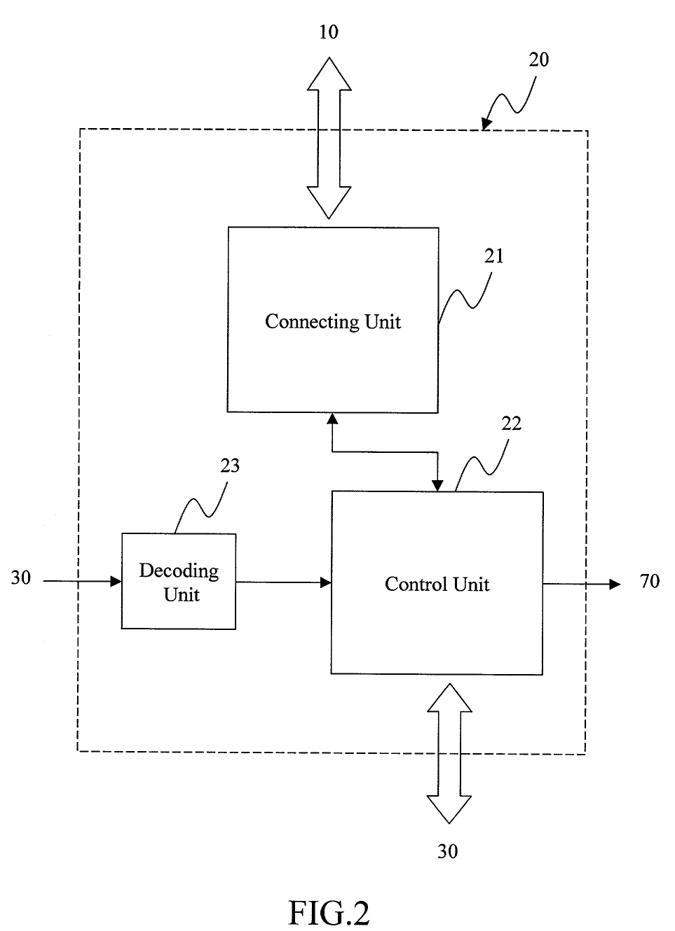

With reference to FIG. 2, the transmission system 20 of the invention includes a connecting unit 21, a control unit 22 and a decoding unit 23. The connecting unit 21 is connected to the independent sub-system 10 and forms a connecting device for a serial port RS232. It is used for connecting with the independent system 10 and transmitting the data and the commands of the server. The control unit 22 is connected with the connecting unit 21 and operates as a UART (Universal Asynchronous Receiver/Transmitter) with the advanced FIFO (First In First Out) function. It is used for temporarily storing and converting the data and the commands of the server into asynchronous signals, which are then transmitted to the connecting unit 21. The interrupt signals are transmitted to the Interrupting Processing Unit 70 of the server by parallel or serial connections. The decoding unit 23 is connected with the control system 30 for receiving the information transmitted from the control system 30 and for transmitting the decoded information to the control unit 22.

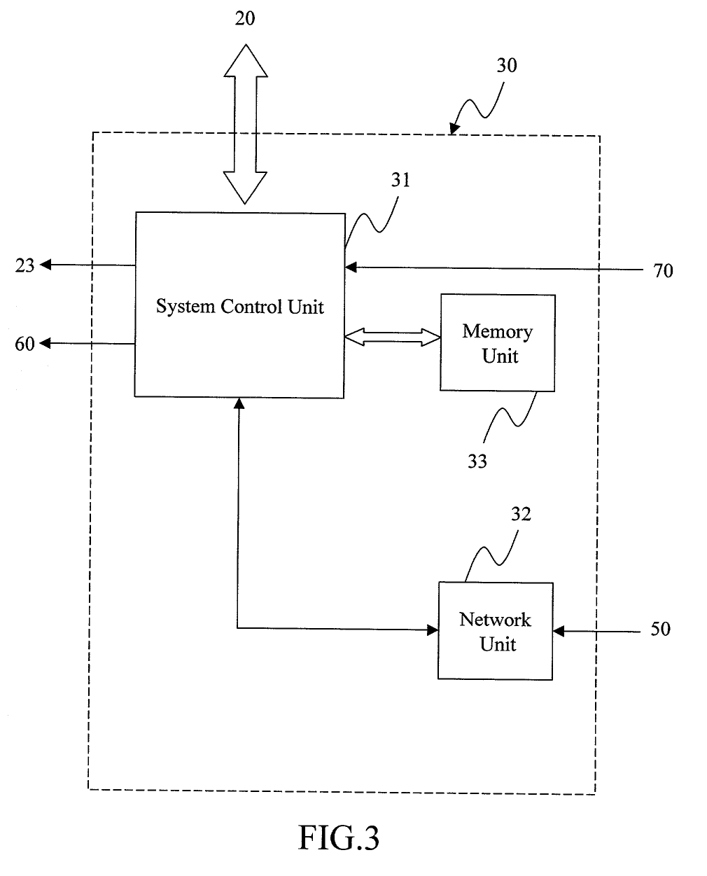

A detailed description of the control system 30 of the invention is shown in FIG. 3.

The disclosed control system 30 includes a system control unit 31, a network unit 32 and a memory unit 33. The system control unit 31 is a SOC (System On Chip). The SOC containing a processor, a memory controller and an interface controller is used for transmitting the information, the commands and the interrupt signals of the external system 50 to the transmission system 20, and to the independent sub-system 10 through the I2C bus. An I2C bus switch unit 60 is provided in the I2C bus for switching the signals of the I2C bus and for transmitting the signals to the different independent sub-systems 10. The system control unit 31 transmits the data and the commands of the external system 50 to the transmission system 20 through the decoding unit 23. The network unit 32 is connected to the external system 50 for receiving the data and the commands from the external system 50 and for transmitting the data and the commands to the system control unit 31. The memory unit 33, which is SDRAM ( Synchronous Dynamic Random Access Memory ), is connected with the system control unit 31 for storing the data and the commands of the external system 50.

A data bus is further installed between the transmission system 20 and the control system 30 for transmitting data and communications. A peripheral component is installed between the network unit 32 and the system control unit 31 to connect to the PCI bus. A memory bus is installed between the system control unit 31 and the memory unit 33 for transmitting data.

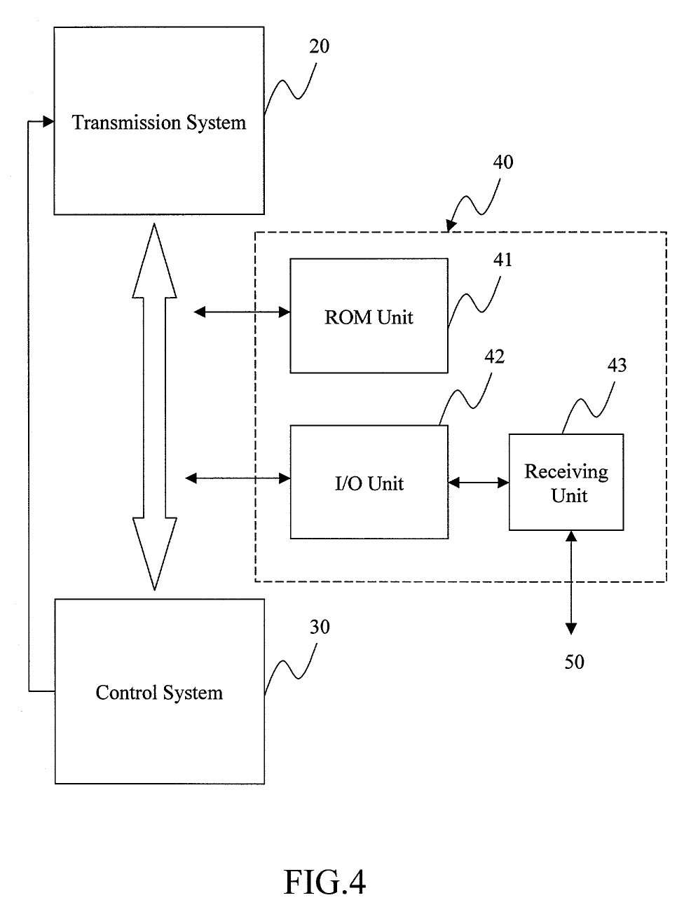

A detailed description of the I/O system 40 in the invention is shown in FIG. 4.

The I/O system 40 includes a ROM unit 41, an I/O unit 42 and a receiving unit 43. The ROM unit 41 is connected with the data bus for storing the data and the commands of the server. The receiving unit 43 is connected with the external system 50. The I/O unit 42, as a super I/O, is connected with the receiving unit 43 for receiving the data and the commands of the external system 50 and for transmitting them to the transmission system 20 and the control system 30 through the data bus.

In summary, the invention utilizes the serial port RS232 and a bus to manage the server and to transmit information. An advantage of the invention is that it increases not only the efficiency of the management but also the speed of data transmission. The invention uses the serial port RS232 to build up one-to-one connections with the independent sub-systems. It further utilizes a UART (Universal Asynchronous Receiver and Transmitter) to receive and transmit information. The virtue of this is that received information can be stored in FIFO, rather than losing information when the processor is busy. Moreover, interrupt signals are also used to manage the server, which is more efficient than managing the server using polling, as in the prior art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A transmission management device of a server implemented with a serial port RS232 and a bus, the transmission management device comprising:
a transmission system connected with an independent sub-system of the server for receiving and storing data and commands of the server and for transmitting the data and the commands of the server to the independent sub-system;
a control system connected with the transmission system for receiving data and commands from an external system and interrupt signals of the server and for transmitting the information, commands and interrupt signals to the independent sub-system through the bus; and
an I/O system connected with the external system for transmitting the data and the commands of the external system to the transmission system and the control system, and for transmitting the data and the commands of the server to the external system.

2. The transmission management device of claim 1, wherein the transmission system comprises:
a connecting unit connected with the independent sub-system for connections with the independent sub-system and for transmitting the data and the commands of the server;
a control unit connected with the connecting unit for temporarily storing and converting the data and the commands to asynchronous signals, for transmitting the asynchronous signals to the connecting unit, and for transmitting the interrupt signal to a CPU; and
a decoding unit connected with the control system for receiving the data transmitted from the control system and for transmitting the information to the control unit after decoding.

3. The transmission management device of claim 2, wherein the connecting unit is a serial port RS232 connecting device.

4. The transmission management device of claim 2, wherein the control unit is an UART (Universal Asynchronous Receiver/Transmitter) with a FIFO (First-In-First-Out) function.

5. The transmission management device of claim 1, wherein the control system comprises:
a network connector for connecting with the external system;
a system control unit connected with the network connector for transmitting the data and the commands of the external system and the interrupt signals to the transmission system and to the independent sub-system through the bus; and
a memory unit connected with the system control unit for storing the data and the commands of the external system.

6. The transmission management device of claim 5, wherein the system control unit is a SOC (System On Chip).

7. The transmission management device of claim 5, wherein the memory unit is a SDRAM ( Synchronous Dynamic Random Access Memory).

8. The transmission management device of claim 5, wherein a PCI Bus is installed between the network connector and the system control unit.

9. The transmission management device of claim 5, wherein a memory bus is installed between the control unit and the memory unit.

10. The transmission management device of claim 5, wherein a data bus is installed between the transmission system and the control system.

11. The transmission management device of claim 1, wherein the I/O system contains:
a receiving unit connected with the external system;
an I/O unit connected with the receiving unit for receiving the data and the commands of the external system and transmitting the data and the commands to the transmission system and the control system; and
a ROM unit connected with the bus for storing the data and the commands of the server.

12. The transmission management device of claim 12, wherein the I/O unit is a super I/O.

13. The transmission management device of claim 11, wherein the ROM unit is a ROM.

14. The transmission management device of claim 1, wherein the interrupt signals are transmitted to the CPU by parallel connections.

15. The transmission management device of claim 1, wherein the interrupt signals are transmitted to the CPU by serial connections.

16. The transmission management device of claim 1, wherein the bus is an I2C bus.

17. The transmission management device of claim 16, wherein the b us contains an I2C bus-switching device for switching the bus signals, thereby transmitting the signals to the different independent sub-systems.

18. The transmission management device of claim 5, wherein the system control unit transmits the data and the commands of the external system to the transmission system through the decoding unit.
